(19) United States
(12) Patent Application Publication
(10) Pub. No.: US 2009/0289937 A1
(43) Pub. Date: Nov. 26, 2009

(54) MULTI-SCALE NAVIGATIONAL VISUALTIZATION

(75) Inventors: Gary W. Flake, Bellevue, WA (US); Blaise Aguera y Arcas, Seattle, WA (US); Brett D. Brewer, Sammamish, WA (US); Steven Drucker, Bellevue, WA (US); Karim Farouki, Seattle, WA (US); Stephen L. Lawler, Redmond, WA (US); Donald James Lindsay, Mountain View, CA (US); Adam Sheppard, Seattle, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/125,514

(22) Filed: May 22, 2008

(51) Int. Cl. G06T 15/00

(52) U.S. Cl. 345/419

(57) ABSTRACT

The claimed subject matter provides a system and/or a method that facilitates providing navigational assistance. An immersive view can include image data that can represent a computer displayable multi-scale image with at least two substantially parallel planes of view in which a first plane and a second plane are alternatively displayable based upon a level of zoom and which are related by a pyramidal volume, wherein the multi-scale image includes a pixel at a vertex of the pyramidal volume. A navigation component can provide navigational assistance via the immersive view based upon navigational input. A display engine can display the immersive view.

### BACKGROUND

Electronic storage mechanisms have enabled accumulation of massive amounts of data. For instance, data that previously required volumes of books to record data can now be stored electronically without expense of printing paper and with a fraction of space needed for storage of paper. In one particular example, deeds and mortgages that were previously recorded in volumes of paper can now be stored electronically. Moreover, advances in sensors and other electronic mechanisms now allow massive amounts of data to be collected in real-time. For instance, GPS systems track a location of a device with a GPS receiver. Electronic storage devices connected thereto can then be employed to retain locations associated with such receiver. Various other sensors are also associated with similar sensing and data retention capabilities.

Today's computers also allow utilization of data to generate various maps (e.g., an orthographic projection map, a road map, a physical map, a political map, a relief map, a topographical map, etc.), displaying various data (e.g., perspective of map, type of map, detail-level of map, etc.) based at least in part upon the user input. For instance, Internet mapping applications allow a user to type in an address or address(es), and upon triggering a mapping application, a map relating to an entered address and/or between addresses is displayed to a user together with directions associated with such map. These maps typically allow minor manipulations/adjustments such as zoom out, zoom in, topology settings, road hierarchy display on the map, boundaries (e.g., city, county, state, country, etc.), rivers, and the like.

However, regardless of the type of map employed and/or the manipulations/adjustments associated therewith, there are certain trade-offs between what information will be provided to the viewer versus what information will be omitted. Often these trade-offs are inherent in the map's construction parameters. For example, whereas a physical map may be more visually appealing, a road map is more useful in assisting travel from one point to another over common routes. Sometimes, map types can be combined such as a road map that also depicts land formation, structures, etc. Yet, the combination of information should be directed to the desire of the user and/or target user. For instance, when the purpose of the map is to assist travel, certain other information, such as political information may not be of much use to a particular user traveling from location A to location B. Thus, incorporating this information may detract from utility of the map. Accordingly, an ideal map is one that provides the viewer with useful information, but not so much that extraneous information detracts from the experience.

Another way of depicting a certain location that is altogether distinct from orthographic projection maps is by way of implementing a first-person perspective. Often this type of view is from a ground level, typically represented in the form of a photograph, drawing, or some other image of a feature as it is seen in the first-person. First-person perspective images, such as “street-side” images, can provide many local details about a particular feature (e.g., a statue, a house, a garden, or the like) that conventionally do not appear in orthographic projection maps. As such, street-side images can be very useful in determining/exploring a location based upon a particular point-of-view because a user can be directly observing a corporeal feature (e.g., a statue) that is depicted in the image. In that case, the user might readily recognize that the corporeal feature is the same as that depicted in the image, whereas with an orthographic projection map, the user might only see, e.g., a small circle that represents the statute that is otherwise indistinguishable from many other statutes similarly represented by small circles or even no symbol that designates the statute based on the orthographic projection map does not include such information.

However, while street-side maps are very effective at supplying local detail information such as color, shape, size, etc., they do not readily convey the global relationships between various features resident in orthographic projection maps, such as relationships between distance, direction, orientation, etc. Accordingly, current approaches to street-side imagery/mapping have many limitations. For example, conventional applications for street-side mapping employ an orthographic projection map to provide access to a specific location then separately display first-person images at that location. Yet, conventional street-side maps tend to confuse and disorient users, while also providing poor interfaces that do not provide a rich, real-world feeling while exploring and/or ascertaining driving directions.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate providing a multi-scale immersive view within navigational or route generation contexts. A navigation component can obtain navigational data related to a route, destination, location or the like and provides route guidance or assistance, geographical information or other information regarding the navigational data. For example, the navigational data can be input such as, but not limited to, a starting address, a location, an address, a zip code, a landmark, a building, an intersection, a business, and any suitable data related to a location and/or point on a map of any area. The navigation component can then provide a route from a starting point to a destination, a map of a location, etc.

The navigation component can aggregate content and generate a multi-scale immersive view based upon the content and associated with the navigational data (e.g., the immersive view can be a view of the route, destination, location, etc.). The multi-scale immersive view can include imagery corresponding to the route, destination or location. The imagery can include image or graphical data, such as, but not limited to, satellite data, aerial data, street-side imagery data, two-dimensional geographic data, three dimensional geographic data, drawing data, video data, ground-level imagery data, and any suitable data related to maps, geography and/or outer space. A display engine can further enable seamless panning and/or zooming on the immersive data The display engine can employ enhanced browsing features (e.g., seamless panning and zooming, etc.) to reveal disparate portions or details of the immersive view which, in turn, allows the immersive view to have virtually limitless amount of real estate for data display.

In accordance with another aspect of the claimed subject matter, the immersive view can be manipulated based upon user input and/or focal point. For instance, a user can pan or zoom the immersive view to browse the view for a particular portion of data (e.g., a particular portion of imagery aggregated within the view). For instance, the user can browse an immersive view generated relative to a desired destination. The initial view can display the destination itself and the can manipulate the view to perceive total surroundings of the destination (e.g., display a view of content across a road from the destination, adjacent to the destination, half-mile before the destination on a route, etc.). Moreover, the immersive view can be manipulated based upon a focal point. The focal point can be a position of a vehicle, a particular point on a route (e.g., destination) or a point located at a particular radius from the position of the vehicle (e.g., 100 feet ahead, 1 mile ahead, etc.). In one aspect, the immersive view can provide high detail or resolution at the focal point.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates providing a multi-scale immersive view in connection with navigation systems.

FIG. 2 illustrates a block diagram of an exemplary system that facilitates providing a multi-scale immersive view in connection with navigation systems.

FIG. 3 illustrates a block diagram of an exemplary system that facilitates employing multi-scale data to generate an immersive view.

FIG. 4 illustrates a block diagram of an exemplary system that facilitates dynamically and seamlessly navigating an immersive view in navigational or route generation systems.

FIG. 5 illustrates a block diagram of an exemplary system that facilitates displaying an immersive view.

FIG. 6 illustrates a block diagram of exemplary system that facilitates enhancing implementation of navigation techniques described herein with a display technique, a browse technique, and/or a virtual environment technique.

FIG. 7 illustrates a block diagram of an exemplary system that facilitates providing an immersive view in connection with navigation systems.

FIG. 8 illustrates an exemplary methodology for employing multi-scale immersive view in connection with navigational assistance.

FIG. 9 illustrates an exemplary methodology that facilitates generating a multi-scale immersive view from imagery associated with navigational data.

FIG. 10 illustrates an exemplary networking environment, wherein the novel aspects of the claimed subject matter can be employed.

FIG. 11 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “engine,” “navigation,” “network,” “structure,” “generator,” “aggregator,” “cloud,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

It is to be appreciated that the subject innovation can be utilized with at least one of a display engine, a browsing engine, a content aggregator, and/or any suitable combination thereof. A “display engine” can refer to a resource (e.g., hardware, software, and/or any combination thereof) that enables seamless panning and/or zooming within an environment in multiple scales, resolutions, and/or levels of detail, wherein detail can be related to a number of pixels dedicated to a particular object or feature that carry unique information. In accordance therewith, the term “resolution” is generally intended to mean a number of pixels assigned to an object, detail, or feature of a displayed image and/or a number of pixels displayed using unique logical image data. Thus, conventional forms of changing resolution that merely assign more or fewer pixels to the same amount of image data can be readily distinguished. Moreover, the display engine can create space volume within the environment based on zooming out from a perspective view or reduce space volume within the environment based on zooming in from a perspective view. Furthermore, a “browsing engine” can refer to a resource (e.g., hardware, software, and/or any suitable combination thereof) that employs seamless panning and/or zooming at multiple scales with various resolutions for data associated with an environment, wherein the environment is at least one of the Internet, a network, a server, a website, a web page, and/or a portion of the Internet (e.g., data, audio, video, text, image, etc.). Additionally, a “content aggregator” can collect two-dimensional data (e.g., media data, images, video, photographs, metadata, etc.) to create a three dimensional (3D) virtual environment that can be explored (e.g., browsing, viewing, and/or roaming such content and each perspective of the collected content).

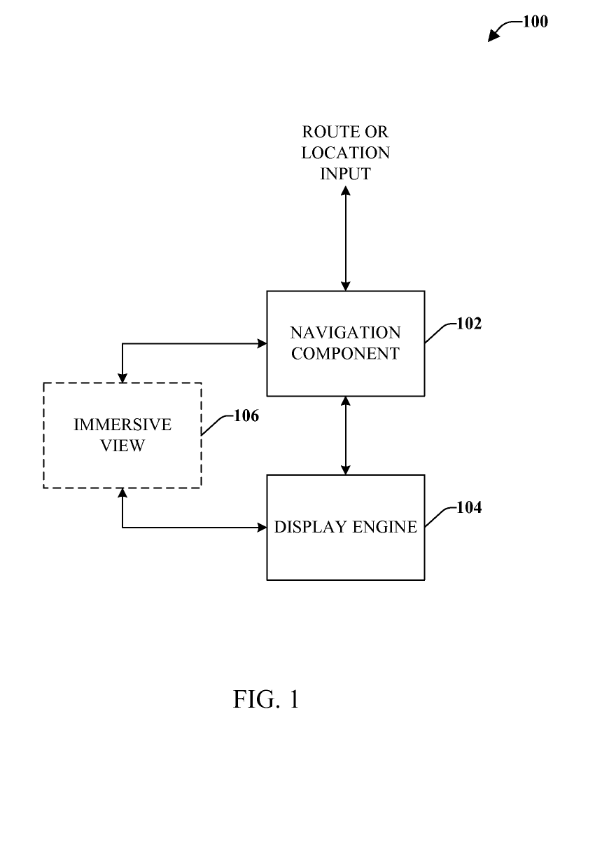

Now turning to the figures, FIG. 1 illustrates a system 100 that facilitates providing a multi-scale immersive view in connection with navigation systems. The system 100 can include a navigation component 102 that can obtain navigational input and provide navigational assistance information. For instance, the navigation component 102 can collect input such as, but not limited to, an address (e.g. a starting or destination address), a location, a zip code, a city name, a landmark designation (e.g. Trafalgar Square), a building designation (e.g. Empire State Building), an intersection, a business name, or any suitable data related to a location, geography and/or a point on a map of any area. Based upon the navigation input, the navigation component 102 can provide navigational assistance. Pursuant to an example, the navigation component 102 can generate a route from a starting point to a destination point. In addition, the navigation component 102 can provide instruction (e.g., voice, graphical, video, etc.) during traversal of the generated route. Further, the navigation component 102 can provide a representation of geographic or map data about a location. For example, the representation can be a road map, a topographic map, a geologic map, a pictorial map, a nautical chart, or the like. The navigation component 102 can enable a user to explore the representation (e.g., pan, zoom, etc.).

The system 100 can further include a display engine 104 that the navigation component 102 can utilize to present the representation or other viewable data. The display engine 104 enables seamless panning and/or zooming within an environment (e.g., a representation of geographic or map data, immersive view 106, etc.) in multiple scales, resolutions, and/or levels of detail, wherein detail can be related to a number of pixels dedicated to a particular object or feature that carry unique information. In addition, the display engine 104 can display an immersive view 106 to facilitate navigational assistance. The immersive view 106 can be viewable data that can be displayed at a plurality of view levels or scales. The immersive view 106 can include viewable data associated with navigational assistance provided by the navigation component 102. For example, the immersive view 106 can depict a generated route, a location, etc.

Pursuant to an illustration, two-dimensional (2D) and/or three-dimensional (3D) content can be aggregated to produce the immersive view 106. For example, content such as, but not limited to, satellite data, aerial data, street-side imagery data, two-dimensional geographic data, three dimensional geographic data, drawing data, video data, ground-level imagery data, and any suitable data related to maps, geography and/or outer space can be collected to construct the immersive view 106. Pursuant to an illustrative embodiment, the immersive view 106 can be relative to a focal point. The focal point can be any point (e.g., geographic location) around which the view is centered. For instance, the focal can be a particular location (e.g., intersection, address, city, etc.) and the immersive view 106 can include aggregated content of the focal point and/or content within a radius from the focal point.

For example, the system 100 can be utilized to viewing, displaying and/or browsing imagery at multiple view levels or scales associated with any suitable immersive view data. The navigation component 102 can receive navigation input that specifies a particular destination. The display engine 104 can present the immersive view 106 of the particular destination. For instance, the immersive view 106 can include street-side imagery of the destination. In addition, the immersive view can include aerial data such as aerial images or satellite images. Further, the immersive view 106 can be a 3D environment that includes a 3D images constructed from aggregated 2D content.

In addition, the system 100 can include any suitable and/or necessary interface(s) (not shown), which provides various adapters, connectors, channels, communication paths, etc. to integrate the navigation component 102 into virtually any operating and/or database system(s) and/or with one another. In addition, the interface(s) can provide various adapters, connectors, channels, communication paths, etc., that provide for interaction with the navigation component 102, the display engine 104, the immersive view 106 and any other device and/or component associated with the system 100.

The system 100 can further include a data store(s) (not shown) that can include any suitable data related to the navigation component 102, the display engine 104, the immersive view 106, etc. For example, the data store(s) can include, but not limited to including, 2D content, 3D object data, user interface data, browsing data, navigation data, user preferences, user settings, configurations, transitions, 3D environment data, 3D construction data, mappings between 2D content and 3D object or image, etc.

It is to be appreciated that the data store(s) can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store(s) of the subject systems and methods is intended to comprise, without being limited to, these and any other suitable types of memory. In addition, it is to be appreciated that the data store(s) can be a server, a database, a hard drive, a pen drive, an external hard drive, a portable hard drive, and the like.

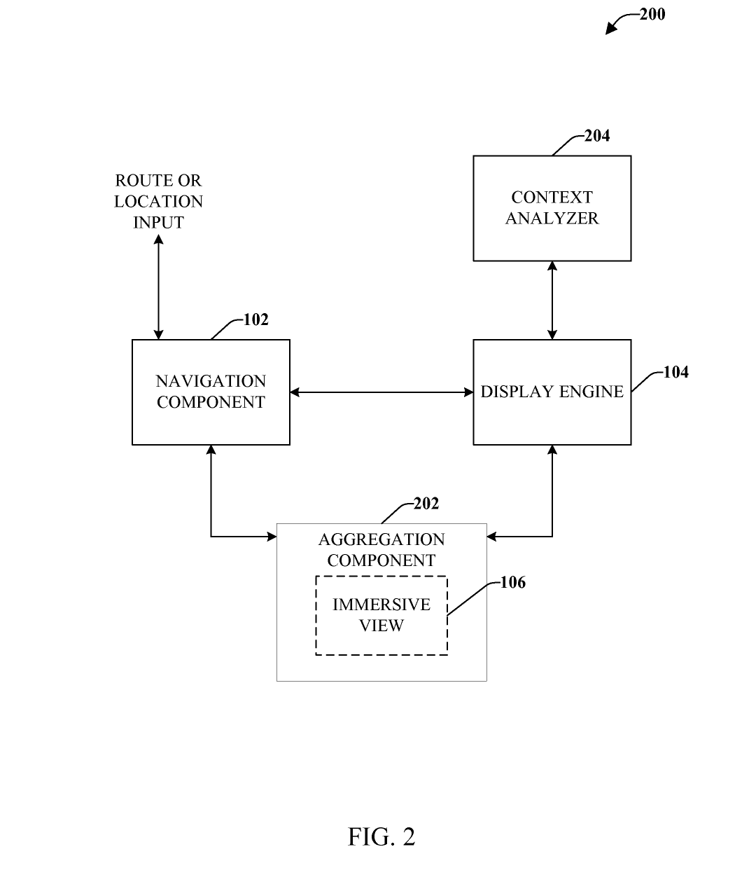

FIG. 2 illustrates a system 200 that facilitates providing a multi-scale immersive view in connection with navigation systems. The system 200 can include a navigation component 102 that provide navigational assistance. Pursuant to an aspect, the navigation component 102 can employ a display engine 104 to present an immersive view 106. The immersive view 106 can include 2D and/or 3D content aggregated to generate a multi-scale image displayable at a plurality of view levels and/or levels of realism. For example, the immersive view can include real images or generated illustrations or representations of real images. The display engine 104 can enable seamless panning and/or zooming of the multi-scale image. In addition, the display engine 104 can obtain, analyze and render large amounts of image content at a high rate. Conventional navigation systems can produce artifacts (e.g. blurriness, stuttering, choppiness, etc.) when map displays are panned, zoomed or changed. However, the display engine 104 enables the navigation component 102 to push large amounts of image data to the display engine 104 for rendering/displaying based upon a focal point determined based upon navigation input (e.g. route, address, location, etc.). It is to be appreciated that the display engine 104 can also pull data from the navigation component 102.

The system 200 can further include an aggregation component 202 that collects two-dimensional (2D) and three-dimensional (2D) content employed to generate the immersive view 106. The 2D and 3D content can include satellite data, aerial data, street-side imagery data, two-dimensional geographic data, three dimensional geographic data, drawing data, video data, ground-level imagery data. The aggregation component 202 can obtain the 2D and/or 3D content from various locations (e.g., the Internet, local data, remote data, server, network, wirelessly collected data, etc.). According to another aspect, the aggregation component 202 can index obtained content. In addition, the indexed content can be retained in a data store (not shown). Navigational input to the navigation component 102 can be employed to retrieve indexed 2D and 3D content associated with the input (e.g., location, address, etc.) to construct the immersive view 106.

The system 200 can also include a context analyzer 204 that obtains context information about a user, a vehicle, a craft, or other entity to determine an appropriate immersive view based upon the context. For example, the context analyzer 204 can infer a focal point for the immersive view 106 from the context of a vehicle employing the navigation component 102 for guidance. Context information can include a speed of a vehicle, origin of a vehicle or operator (e.g., is the operator in an unfamiliar city or location), starting location, destination location, etc. For instance, the context analyzer 204 can discern that a vehicle is traveling at a high speed. Accordingly, the context analyzer 204 can select a focal point for the immersive view 106 that is a greater distance in front of the vehicle than would be if the vehicle was traveling slowly. An operator or passenger of the vehicle can then observe the immersive view to understand upcoming geography with sufficient time to make adjustments. In addition, the context analyzer 204 can determine a level of detail or realism to utilize with the immersive view 106. For a high speed vehicle, greater detail and/or realism can be displayed for locations a great distance away from the position of the vehicle than can displayed for locations at a short distance. Pursuant to another illustration, the context analyzer 204 can ascertain that an operator is lost or unsure about a location (e.g., the operator is observed to be looking around frequently). Accordingly, the immersive view 106 can be displayed in high detail to facilitate orienting the operator.

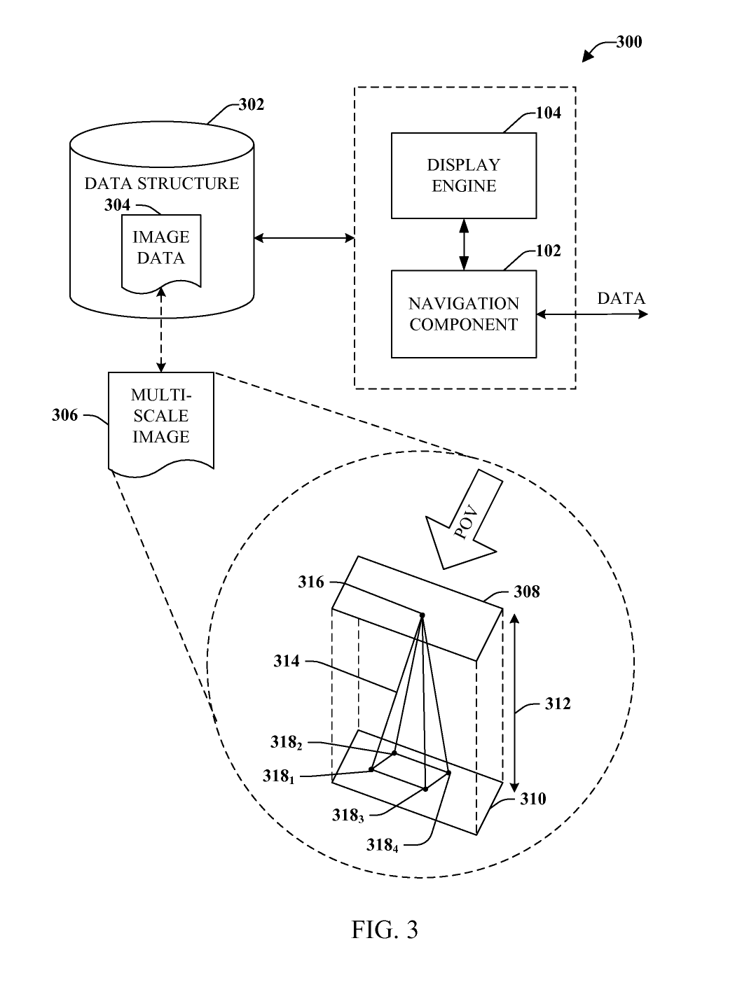

FIG. 3 illustrates a system 300 that facilitates employing multi-scale data to generate an immersive view. Generally, system 300 can include a data structure 302 with image data 304 that can represent, define, and/or characterize computer displayable multi-scale image 306, wherein a display engine 104 can access and/or interact with at least one of the data structure 302 or the image data 304 (e.g., the image data 304 can be any suitable data that is viewable and/or displayable). In particular, image data 304 can include two or more substantially parallel planes of view (e.g., layers, scales, etc.) that can be alternatively displayable, as encoded in image data 304 of data structure 302. For example, image 306 can include first plane 308 and second plane 310, as well as virtually any number of additional planes of view, any of which can be displayable and/or viewed based upon a level of zoom 312. For instance, planes 308, 310 can each include content, such as on the upper surfaces that can be viewable in an orthographic fashion. At a higher level of zoom 312, first plane 308 can be viewable, while at a lower level zoom 312 at least a portion of second plane 310 can replace on an output device what was previously viewable.

Moreover, planes 308, 310, et al., can be related by pyramidal volume 314 such that, e.g., any given pixel in first plane 308 can be related to four particular pixels in second plane 310. It should be appreciated that the indicated drawing is merely exemplary, as first plane 308 need not necessarily be the top-most plane (e.g., that which is viewable at the highest level of zoom 312), and, likewise, second plane 310 need not necessarily be the bottom-most plane (e.g., that which is viewable at the lowest level of zoom 312). Moreover, it is further not strictly necessary that first plane 308 and second plane 310 be direct neighbors, as other planes of view (e.g., at interim levels of zoom 312) can exist in between, yet even in such cases the relationship defined by pyramidal volume 314 can still exist. For example, each pixel in one plane of view can be related to four pixels in the subsequent next lower plane of view, and to 316 pixels in the next subsequent plane of view, and so on. Accordingly, the number of pixels included in pyramidal volume at a given level of zoom, l, can be described as p=4^{l}, where l is an integer index of the planes of view and where l is greater than or equal to zero. It should be appreciated that p can be, in some cases, greater than a number of pixels allocated to image 306 (or a layer thereof) by a display device (not shown) such as when the display device allocates a relatively small number of pixels to image 306 with other content subsuming the remainder or when the limits of physical pixels available for the display device or a viewable area is reached. In these or other cases, p can be truncated or pixels described by p can become viewable by way of panning image 306 at a current level of zoom 312.

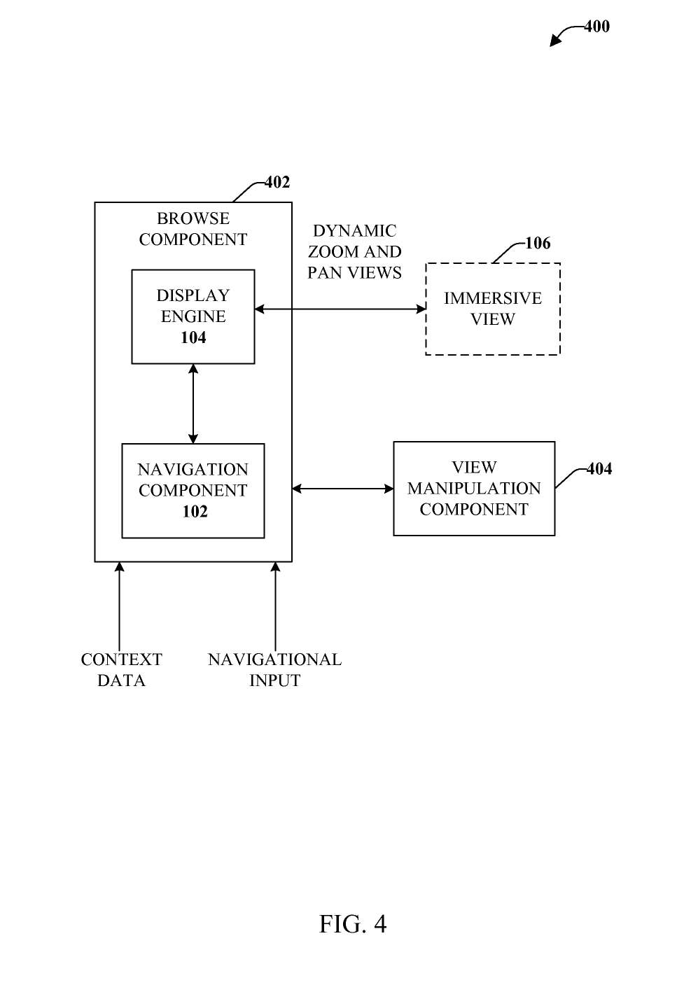

However, in order to provide a concrete illustration, first plane 308 can be thought of as a top-most plane of view (e.g., l=0) and second plane 310 can be thought of as the next sequential level of zoom 312 (e.g., l=1), while appreciating that other planes of view can exist below second plane 310, all of which can be related by pyramidal volume 314. Thus, a given pixel in first plane 308, say, pixel 316, can by way of a pyramidal projection be related to pixels 318₁-318₄ in second plane 310. The relationship between pixels included in pyramidal volume 314 can be such that content associated with pixels 318₁-318₄ can be dependent upon content associated with pixel 316 and/or vice versa. It should be appreciated that each pixel in first plane 308 can be associated with four unique pixels in second plane 310 such that an independent and unique pyramidal volume can exist for each pixel in first plane 308. All or portions of planes 308, 310 can be displayed by, e.g. a physical display device with a static number of physical pixels, e.g., the number of pixels a physical display device provides for the region of the display that displays image 306 and/or planes 308, 310. Thus, physical pixels allocated to one or more planes of view may not change with changing levels of zoom 312, however, in a logical or structural sense (e.g., data included in data structure 302 or image data 304) each successive lower level of zoom 312 can include a plane of view with four times as many pixels as the previous plane of view, which is further detailed in connection with FIG. 4, described below.

The system 300 can further include a navigation component 102 that provides navigational assistance via the display engine 104 and the multi-scale image 306 (e.g., immersive view). The navigation component 102 can receive a portion of data (e.g., a portion of navigational input, etc.) in order to reveal a portion of viewable data (e.g., viewable object, displayable data, geographical data, map data, street-side imagery, aerial imagery, satellite imagery, the data structure 302, the image data 304, the multi-scale image 306, etc.). In general, the display engine 104 can provide exploration (e.g., seamless panning, zooming, etc.) within viewable data (e.g., the data structure 102, the portion of image data 104, the multi-scale image 106, etc.) in which the viewable data can correspond to navigational assistance information (e.g., a map, a route, street-side imagery, aerial imagery, etc.).

For example, the system 300 can be utilized in viewing and/or displaying view levels on any suitable geographical or navigational imagery. For example, navigation imagery (e.g., street-side imagery, aerial imagery, illustrations, etc.) can be viewed in accordance with the subject innovation. At a first level view (e.g., city view), navigation imagery of a city about a focal point can be displayed. At a second level view (e.g., a zoom in to a single block), street-side imagery, aerial imagery, or illustrative imagery of the single block can be displayed about the focal point.

Furthermore, the display engine 104 and/or the navigation component 102 can enable transitions between view levels of data to be smooth and seamless. For example, transitioning from a first view level with particular navigational imagery to a second view level with disparate navigation imagery can be seamless and smooth in that the imagery can be manipulated with a transitioning effect. For example, the transitioning effect can be a fade, a transparency effect, a color manipulation, blurry-to-sharp effect, sharp-to-blurry effect, growing effect, shrinking effect, etc.

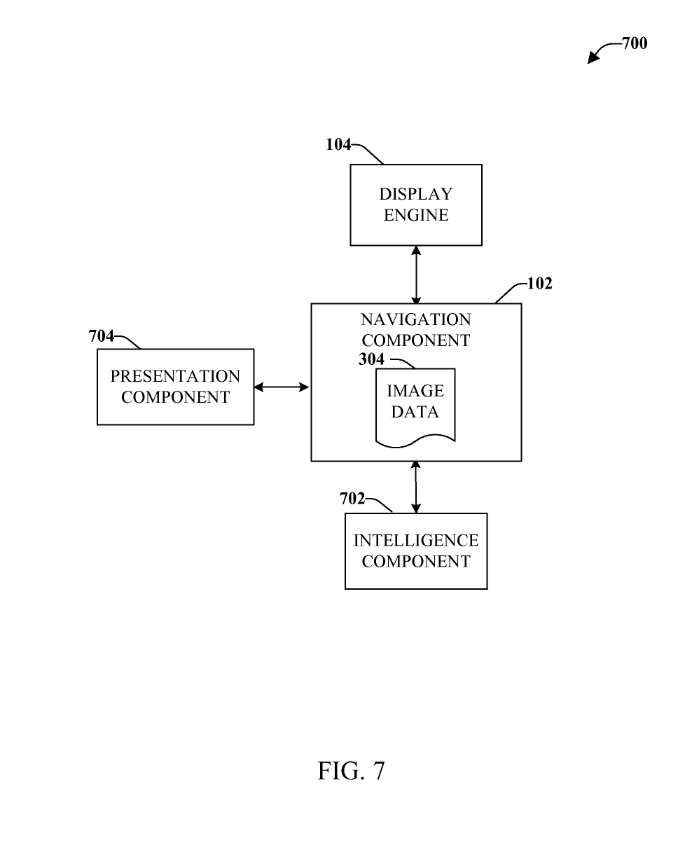

It is to be appreciated that the system 300 can enable a zoom within a 3-dimensional (3D) environment in which the navigation component 102 can employ imagery associated with a portion of such 3D environment. In particular, a content aggregator (not shown but discussed in FIG. 7) can collect a plurality of two dimensional (2D) content (e.g., media data, images, video, photographs, metadata, trade cards, etc.) to create a three dimensional (3D) virtual environment that can be explored (e.g., displaying each image and perspective point). In order to provide a complete 3D environment to a user within the virtual environment, authentic views (e.g., pure views from images) are combined with synthetic views (e.g., interpolations between content such as a blend projected onto the 3D model). Thus, a virtual 3D environment can be explored by a user, wherein the environment is created from a group of 2D content. The navigation component 102 can employ the 3D virtual environment to facilitate navigational guidance. It is to be appreciated that the claimed subject matter can be applied to 2D environments (e.g., including a multi-scale mage having two or more substantially parallel planes in which a pixel can be expanded to create a pyramidal volume) and/or 3D environments (e.g., including 3D virtual environments created from 2D content with the content having a portion of content and a respective viewpoint).

FIG. 4 illustrates a system 400 that facilitates dynamically and seamlessly navigating an immersive view that provides navigational assistance or guidance. The system 400 can include the display engine 104 that can interact with an immersive view 106 to display navigational or geographic imagery associated with a route, location, etc. Furthermore, the system 400 can include the navigation component 102 that can provide navigational assistance and, further, determine imagery to include in the immersive view 106. Such determination can be based upon input obtained by the navigation component 102. For example, input can specify a particular destination or location or interest. The immersive view 106 can then include imagery corresponding to that particular destination or location of interest. For instance, the display engine 104 can allow seamless zooms, pans, and the like on the immersive view 106. For example, the immersive view 106 can be any suitable viewable data for navigational assistance such as atlas data, map data, street-side imagery or photographs, aerial imagery or photographs, satellite imagery, accurate illustrations of geography, topology data, etc. Moreover, the navigation component 102 can provide any additional navigational assistance beyond the immersive view 106 (e.g., voice guidance, route markers, etc.).

The system 400 can further include a browse component 402 that can leverage the display engine 104 and/or the navigation component 102 in order to allow interaction or access with the immersive view 106 across a network, server, the web, the Internet, cloud, and the like. The browse component 402 can receive at least one of context data (e.g., a speed of a vehicle, origin of a vehicle or operator, starting location, destination location, etc.) or navigational input (e.g., an address, a location, a zip code, a city name, a landmark designation, a building designation, an intersection, a business name, or any suitable data related to a location, etc.). The browse component 402 can leverage the display engine 104 and/or the navigation component 104 to enable viewing or displaying an immersive view based upon the obtained context data and navigational input. For example, the browsing component 402 can receive navigational input that defines a particular location, wherein the immersive view 106 can be displayed that includes imagery associated with the particular location. It is to be appreciated that the browse component 402 can be any suitable data browsing component such as, but not limited to, a portion of software, a portion of hardware, a media device, a mobile communication device, a laptop, a browser application, a smartphone, a portable digital assistant (PDA), a media player, a gaming device, and the like.

The system 400 can further include a view manipulation component 404. The view manipulation component 404 can control the immersive view 106 displayed by the display engine 104 based upon a focal point or other factors. For example, the immersive view 106 can include imagery associated with a focal point 100 feet ahead of a vehicle. The view manipulation component 404 can instruct the display engine 104 to provide seamless panning, zooming, or alteration of the immersive view such that the imagery displayed maintains a distance of 100 feet in front of the vehicle. Moreover, the view manipulation component 404 can develop a fly-by scenario wherein the display engine 104 can present the immersive view 106 that traverse a route or other path from two geographic points. For instance, the display engine 104 can provide an immersive view 106 that zooms or pans imagery such that the immersive view 106 provides scrolling imagery similar to what a user experiences during actual traversal of the route.

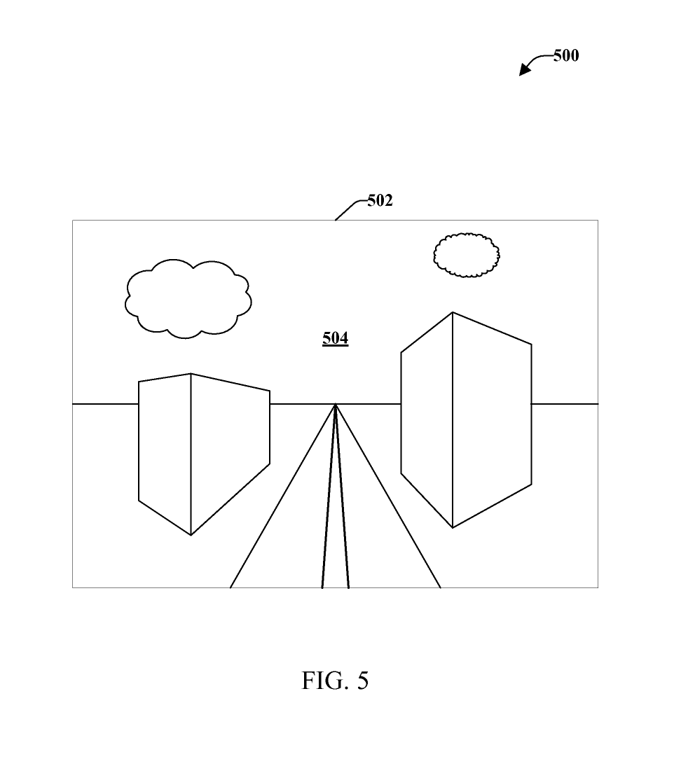

FIG. 5 illustrates a system 500 that facilitates employing navigational imagery in connection with navigation systems. The system 500 includes an example immersive view 502. The immersive view 502 displays navigational imagery 504 associated with a route, location, destination, etc. In the system 500, the navigational imagery 504 displayed includes ground-level or street-side imagery. The imagery can include a photograph taken of the location, a construct illustration of the location or a generation 3D image from aggregated 2D content. A display engine (not shown), similar to the display engine described supra, can facilitate changing the navigation imagery 504 in a seamless manner according to motion of a vehicle, user input, etc. For instance, the multi-scale capabilities of the display engine to seamless zoom a pyramidal volume to simulate motion, video, animation, etc. on the immersive view 502 during traversal of a route. Pursuant to an illustration, a pixel on the navigational imagery 504 that is in close proximity to the vanishing point of the imagery, can be seamlessly zoomed to a second view level wherein the pixel corresponds to a plurality of pixels providing more detail on a portion of the navigational imagery 504.

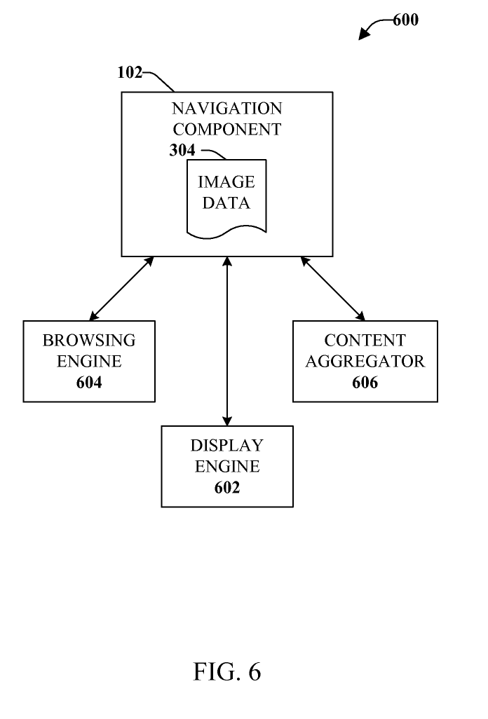

FIG. 6 illustrates a system 600 that facilities enhancing implementation of navigation techniques described herein with a display technique, a browse technique, and/or a virtual environment technique. The system 600 can include the navigation component 102 and a portion of image data 304. The system 600 can further include a display engine 602 that enables seamless pan and/or zoom interaction with any suitable displayed data, wherein such data can include multiple scales or views and one or more resolutions associated therewith. In other words, the display engine 602 can manipulate an initial default view for displayed data by enabling zooming (e.g., zoom in, zoom out, etc.) and/or panning (e.g., pan up, pan down, pan right, pan left, etc.) in which such zoomed or panned views can include various resolution qualities. The display engine 602 enables visual information to be smoothly browsed regardless of the amount of data involved or bandwidth of a network. Moreover, the display engine 602 can be employed with any suitable display or screen (e.g., portable device, cellular device, monitor, plasma television, etc.). The display engine 602 can further provide at least one of the following benefits or enhancements: 1) speed of navigation can be independent of size or number of objects (e.g., data); 2) performance can depend on a ratio of bandwidth to pixels on a screen or display; 3) transitions between views can be smooth; and 4) scaling is near perfect and rapid for screens of any resolution.

For example, an image can be viewed at a default view with a specific resolution. Yet, the display engine 602 can allow the image to be zoomed and/or panned at multiple views or scales (in comparison to the default view) with various resolutions. Thus, a user can zoom in on a portion of the image to get a magnified view at an equal or higher resolution. By enabling the image to be zoomed and/or panned, the image can include virtually limitless space or volume that can be viewed or explored at various scales, levels, or views with each including one or more resolutions. In other words, an image can be viewed at a more granular level while maintaining resolution with smooth transitions independent of pan, zoom, etc. Moreover, a first view may not expose portions of information or data on the image until zoomed or panned upon with the display engine 602.

A browsing engine 604 can also be included with the system 600. The browsing engine 604 can leverage the display engine 602 to implement seamless and smooth panning and/or zooming for any suitable data browsed in connection with at least one of the Internet, a network, a server, a website, a web page, and the like. It is to be appreciated that the browsing engine 604 can be a stand-alone component, incorporated into a browser, utilized with in combination with a browser (e.g., legacy browser via patch or firmware update, software, hardware, etc.), and/or any suitable combination thereof. For example, the browsing engine 604 can be incorporate Internet browsing capabilities such as seamless panning and/or zooming to an existing browser. For example, the browsing engine 604 can leverage the display engine 602 in order to provide enhanced browsing with seamless zoom and/or pan on a website, wherein various scales or views can be exposed by smooth zooming and/or panning.

The system 600 can further include a content aggregator 606 that can collect a plurality of two dimensional (2D) content (e.g., media data, images, video, photographs, metadata, trade cards, etc.) to create a three dimensional (3D) virtual environment that can be explored (e.g., displaying each image and perspective point). In order to provide a complete 3D environment to a user within the virtual environment, authentic views (e.g., pure views from images) are combined with synthetic views (e.g., interpolations between content such as a blend projected onto the 3D model). For instance, the content aggregator 606 can aggregate a large collection of photos of a place or an object, analyze such photos for similarities, and display such photos in a reconstructed 3D space, depicting how each photo relates to the next. It is to be appreciated that the collected content can be from various locations (e.g., the Internet, local data, remote data, server, network, wirelessly collected data, etc.). For instance, large collections of content (e.g., gigabytes, etc.) can be accessed quickly (e.g., seconds, etc.) in order to view a scene from virtually any angle or perspective. In another example, the content aggregator 606 can identify substantially similar content and zoom in to enlarge and focus on a small detail. The content aggregator 606 can provide at least one of the following: 1) walk or fly through a scene to see content from various angles; 2) seamlessly zoom in or out of content independent of resolution (e.g., megapixels, gigapixels, etc.); 3) locate where content was captured in relation to other content; 4) locate similar content to currently viewed content; and 6) communicate a collection or a particular view of content to an entity (e.g., user, machine, device, component, etc.).

FIG. 7 illustrates a system 700 that employs intelligence to facilitate facilitates providing an immersive view in connection with navigation systems. The system 700 can include the data structure (not shown), the image data 304, the navigation component 102, and the display engine 104. It is to be appreciated that the data structure (not shown), the image data 304, the navigation component 102, and/or the display engine 104 can be substantially similar to respective data structures, image data, navigation components, and display engines described in previous figures. The system 700 further includes an intelligence component 702. The intelligence component 702 can be utilized by at least one of the navigation component 102 to facilitate selecting a route, focal point, imagery collections, view details, etc. For instance, the intelligence component 702 can infer whether a particular focal point is to be employed based upon navigational input and/or context of a user, operator vehicle, etc. Moreover, the intelligence component 702 can infer a level of detail or realism to utilize in displaying navigation imagery. In addition, the intelligence component 702 can infer optimal publication or environment settings, display engine settings, security configurations, durations for data exposure, sources of the navigational imagery, optimal form of imagery (e.g., video, handwriting, audio, etc.), and/or any other data related to the system 700.

The intelligent component 702 can employ value of information (VOI) computation in order to provide navigation assistance for a particular user. For instance, by utilizing VOI computation, the most ideal focal point and/or level of realism can be identified and exposed for a specific user. Moreover, it is to be understood that the intelligent component 702 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The system 700 can further utilize a presentation component 704 that provides various types of user interfaces to facilitate interaction with the navigation component 102. As depicted, the presentation component 704 is a separate entity that can be utilized with navigation component 102. However, it is to be appreciated that the presentation component 704 and/or similar view components can be incorporated into the navigation component 102 and/or a stand-alone unit. The presentation component 704 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into at least one of the navigation component 102 or the display engine 104.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

Pursuant to another aspect, the presentation component 704 can be integrated within a vehicle to provide navigational assistance to an operator or passenger of the vehicle. For instance, the presentation component 704 can utilize a dashboard display to exhibit multi-scale immersive views (e.g., street-side imagery, aerial imagery, satellite imagery, etc.). Moreover, system 700 can incorporate a plurality of displays with a vehicle that are associated with at least one of a rear view mirror, a side view mirror, etc. In an illustrative embodiment, imagery of a view behind a focal point can be displayed in the rear view mirror and imagery of a view to the left or right of the focal point can be displayed in the left and right side view mirrors, respectively.

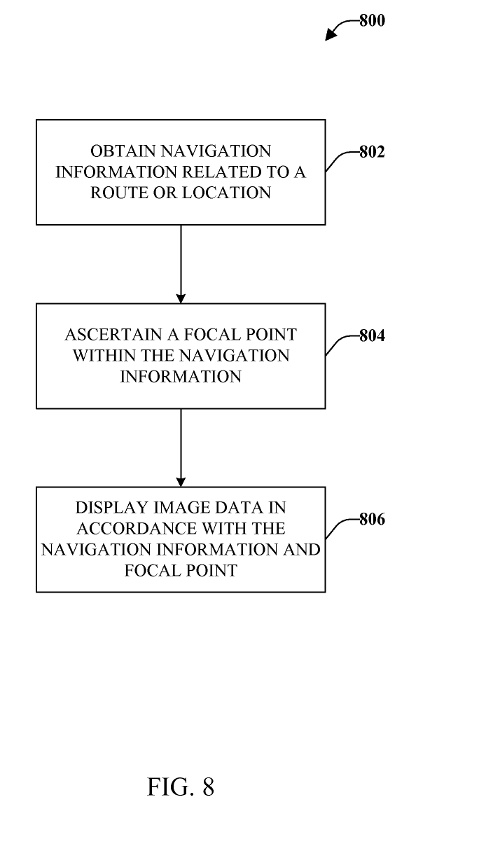

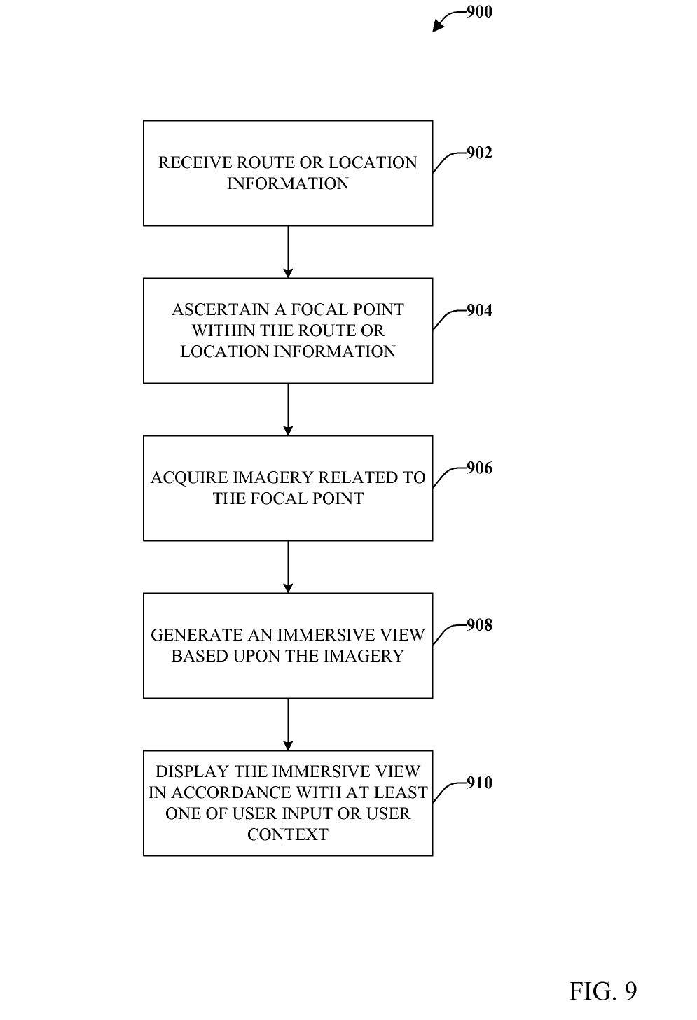

FIGS. 8-9 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 8 illustrates a method 800 that facilitates employing multi-scale immersive view in connection with navigational assistance. At reference numeral 802, navigation information related to a route or location can be obtained. For example, the navigation information can be a request for navigational assistance (e.g., guidance on a route between two points), an address, a location, a landmark designation, a city, etc. At reference numeral 804, a focal point within the navigation information is ascertained. The focal point can be any point (e.g., geographic location) associated with the navigation information. For instance, the focal can be a particular location (e.g., intersection, address, city, etc.) on a route. In addition, the focal point can be a point relative to a vehicle or user. Pursuant to an illustration, the focal point can be established to be 100 feet in front of a moving vehicle. According to an aspect, the focal point can be variable. At reference numeral 806, image data is displayed in accordance with the navigation information and focal point. For instance, the image data can be aerial data, map data, topology data, satellite data, ground-level data, street-side data, etc. Such data can be displayed centered around the focal point. Pursuant to an example, the image data (e.g. street side images, aerial images, etc.) corresponding to a destination can be displayed. The image data can be a multi-scale image that can be changed, panned or zoomed in a seamless fashion as a route is traveled. In particular, the displayed image data can include various layers, views, and/or scales associated therewith. Thus, image data can include a default view wherein a zooming in can dive into the data to deeper levels, layers, views, and/or scales. It is to be appreciated that diving (e.g., zooming into the data at a particular location) into the data can provide at least one of the default view on such location in a magnified depiction, exposure of additional data not previously displayed at such location, or active data revealed based on the deepness of the dive and/or the location of the origin of the dive. It is to be appreciated that once a zoom in on the viewable data is performed, a zoom out can also be employed which can provide additional data, de-magnified views, and/or any combination thereof.

FIG. 9 illustrates a method 900 for facilitates generating a multi-scale immersive view from imagery associated with navigational data. At reference numeral 902, route or location information is received. At reference numeral 904, a focal point within the route or location information is ascertained. For example, context of a vehicle or user can be utilized to determine a focal point. Pursuant to an illustration, a focal point for a fast moving vehicle can be established a larger distance in front of the vehicle. At reference numeral 906, imagery related to the focal point can be acquired. For example, the imagery can include 2D and 3D content such as satellite data, aerial data, street-side imagery data, two-dimensional geographic data, three dimensional geographic data, drawing data, video data, ground-level imagery data. The imagery can be acquired from various locations (e.g., the Internet, local data, remote data, server, network, wirelessly collected data, etc.). At reference numeral 908, an immersive view based upon the imagery is generated. The immersive view can be viewable data (e.g., acquired imagery) that can be displayed at a plurality of view levels or scales. The immersive view can provide navigation assistance. For example, the immersive view can depict a generated route, a location, etc. At reference numeral 910, the immersive view is displayed in accordance with at least one of user input or user context. For example, a user can provide input that seamlessly zooms or pans the immersive view. In addition, context of the user can be utilized to change focal point about which the immersive view is centered. For instance, as the user travels a route, the focal point (and the immersive view) can be adjusted according to the travel.

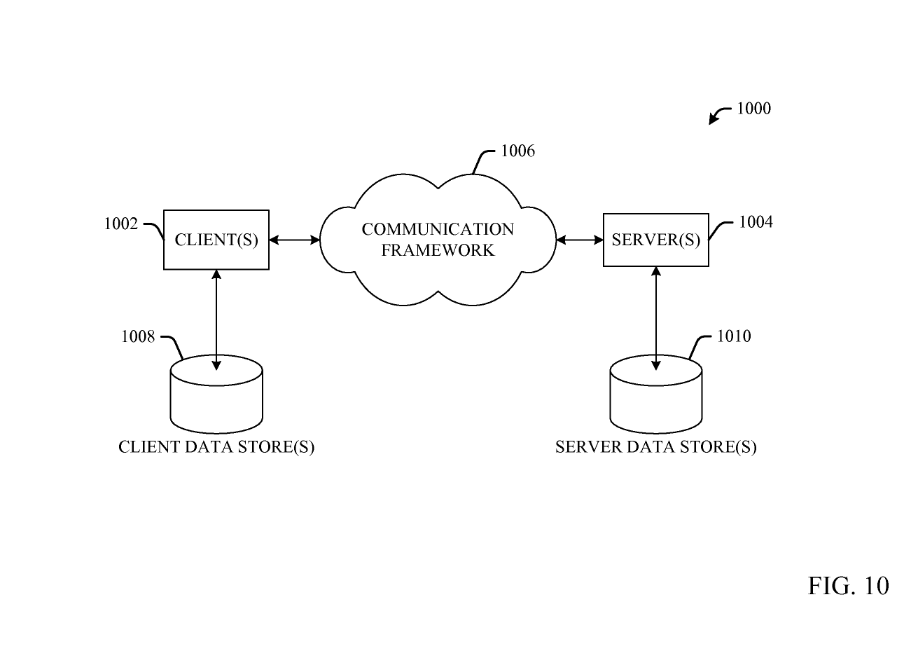

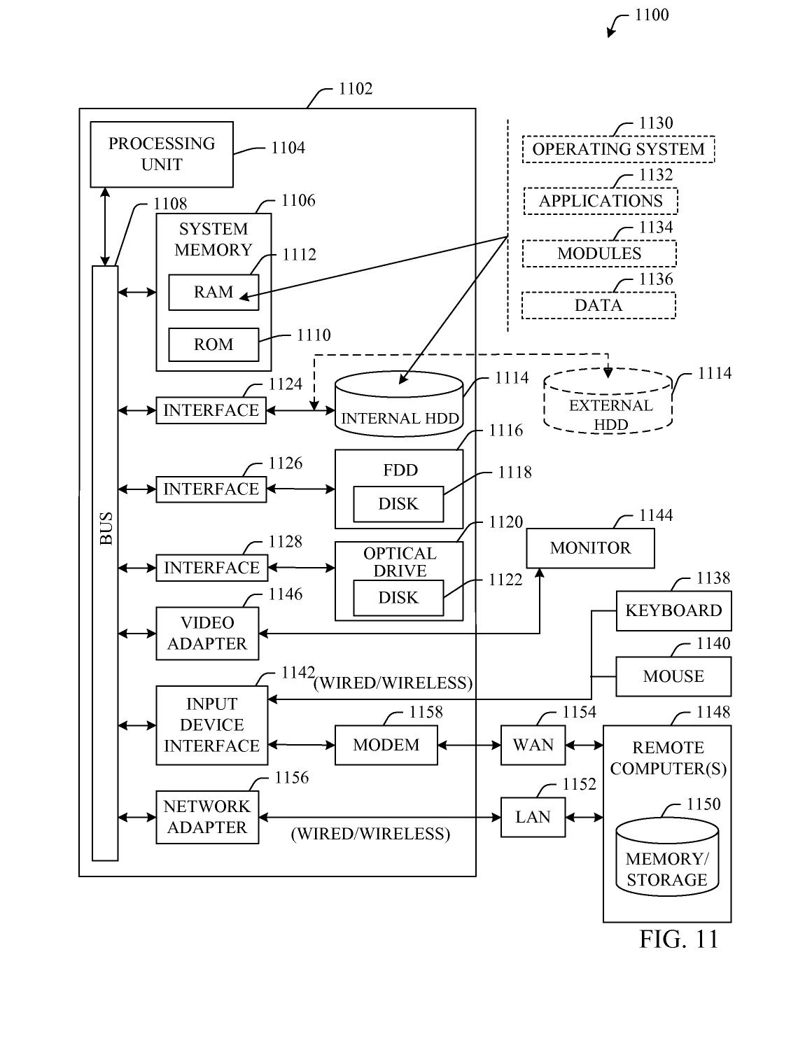

In order to provide additional context for implementing various aspects of the claimed subject matter, FIGS. 10-11 and the following discussion is intended to provide a brief, general description of a suitable computing environment in which the various aspects of the subject innovation may be implemented. For example, an annotation component can reveal annotations based on a navigated location or view level, as described in the previous figures, can be implemented or utilized in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 10 is a schematic block diagram of a sample-computing environment 1000 with which the claimed subject matter can interact. The system 1000 includes one or more client(s) 1010. The client(s) 1010 can be hardware and/or software (e.g., threads, processes, computing devices). The system 1000 also includes one or more server(s) 1020. The server(s) 1020 can be hardware and/or software (e.g., threads, processes, computing devices). The servers 1020 can house threads to perform transformations by employing the subject innovation, for example.

One possible communication between a client 1010 and a server 1020 can be in the form of a data packet adapted to be transmitted between two or more computer processes. The system 1000 includes a communication framework 1040 that can be employed to facilitate communications between the client(s) 1010 and the server(s) 1020. The client(s) 1010 are operably connected to one or more client data store(s) 1050 that can be employed to store information local to the client(s) 1010. Similarly, the server(s) 1020 are operably connected to one or more server data store(s) 1030 that can be employed to store information local to the servers 1020.

With reference to FIG. 11, an exemplary environment 1100 for implementing various aspects of the claimed subject matter includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also includes removable/non-removable, volatile/non-volatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in the suitable operating environment 1100. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the claimed subject matter can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A computer-implemented system that facilitates navigation, comprising:
a navigation component that provides navigational assistance based at least in upon navigational input; and
a display engine that displays an immersive view in accordance with the navigational guidance, the immersive view is a portion of viewable data that represents a computer displayable multi-scale image with at least two substantially parallel planes of view in which a first plane and a second plane are alternatively displayable and which are related by a pyramidal volume, the multi-scale image includes a pixel at a vertex of the pyramidal volume.

2. The system of claim 1, the first and second planes are alternatively displayable based at least in part on a level of zoom.

3. The system of claim 1, the first and second planes are alternatively displayable based at least in part on a level of realism.

4. The system of claim 1, the second plane of view displays a portion of the first plane of view at one of a different scale or a different resolution.

5. The system of claim 1, the second plane of view displays a portion of the immersive view that is graphically or visually unrelated to the first plane of view.

6. The system of claim 1, the second plane of view displays a portion of the image data that is disparate than the portion of the image data associated with the first plan of view

7. The system of claim 1, further comprising an aggregation component that collects two-dimensional (2D) and three-dimensional (2D) content employed to generate the immersive view.

8. The system of claim 7, the 2D and 3D content can include at least one of satellite data, aerial data, street-side imagery data, two-dimensional geographic data, three dimensional geographic data, drawing data, video data, or ground-level imagery data.

9. The system of claim 7, the aggregation component can acquired the 2D and 3D content from a network.

10. The system of claim 7, the aggregation component indexes the collected content.

11. The system of claim 1, further comprising a context analyzer that obtains context information about at least one of a user, a vehicle, or a craft.

12. The system of claim 11, the context analyzer determines an appropriate immersive view based upon the context information.

13. The system of claim 11, the context analyzer ascertains a focal point for the immersive view.

14. The system of claim 1, further comprising a cloud that hosts at least one of the display engine, the navigation component, or the immersive view, wherein the cloud is at least one resource that is maintained by a party and accessible by an identified user over a network.

15. The system of claim 1, the display engine implements a seamless transition between a plurality of planes of view, the seamless transition is provided by a transitioning effect that is at least one of a fade, a transparency effect, a color manipulation, a blurry-to-sharp effect, a sharp-to-blurry effect, a growing effect, or a shrinking effect.

16. The system of claim 1, further comprising a view manipulation component that manages the immersive view based at least in part on a focal point.

17. A computer-implemented method that facilitates employing multi-scale imagery in navigation systems, comprising:
obtaining navigation information, the navigation information includes at least one of a location or route;
ascertaining a focal point based at least in part on the navigation information; and
rendering image data in accordance with the navigation information and focal point.

18. The method of claim 17, further comprising smoothly transitioning between image data on a first view level and image data second view level during route traversal.

19. The method of claim 17, the image data represents an immersive view that includes a portion of viewable data that represents a computer displayable multi-scale image with at least two substantially parallel planes of view in which a first plane and a second plane are alternatively displayable and which are related by a pyramidal volume, the multi-scale image includes a pixel at a vertex of the pyramidal volume.

20. A computer-implemented system that facilitates providing navigational guidance with multi-scale imagery, comprising:
means for obtaining navigation information related to a route or location;
means for acquiring context information corresponding to at least one of a user or vehicle;
means for determining a focal point based at least in part on the navigation information and context information;
means for aggregating image data related to the determined focal point, the image data includes at least one of satellite data, aerial data, street-side imagery data, two-dimensional geographic data, three dimensional geographic data, drawing data, video data, or ground-level imagery data;
means for representing the image data as a immersive view, the immersive view is a computer displayable multi-scale image with at least two substantially parallel planes of view in which a first plane and a second plane are alternatively displayable based upon a level of zoom and which are related by a pyramidal volume, the image includes a pixel at a vertex of the pyramidal volume; and
means for manipulating the immersive view during route traversal.
